(19) United States
(12) Patent Application Publication
(10) Pub. No.: US 2006/0064327 A1
(43) Pub. Date: Mar. 23, 2006

(54) Global synchronization technology

(76) Inventors: Jeffrey A. Simon, Marietta, GA (US); Ronald J. Sampson JR., Sugar Hill, GA (US)

Correspondence Address: Burns & Levinson LLP, Suite 300, 1030 Fifteenth Street, N.W., Washington, DC, 20005-1501, US

(21) Appl. No.: 11/207,156

(22) Filed: Aug. 18, 2005

Related U.S. Application Data
(60) Provisional application No. 60/602,918, filed on Aug. 19, 2004.

(51) Int. Cl. G06F 19/00

(52) U.S. Cl. 705/3; 709/248

(57) ABSTRACT

A system and method for synchronizing data transmitted from at least one wireless portable device to at least one server for storage on a database, and for providing conflict resolution of data simultaneously transmitted from the at least one wireless portable device to the at least one server.

### CROSS REFERENCE TO RELATED APPLICATIONS

This application relates to and claims priority benefit under 35 U.S.C. § 119(e) to U.S. Provisional Patent Application Ser. No. 60/602,918, entitled “Global Synchronization Technology”, filed Aug. 19, 2004. U.S. patent application Ser. No. 10/935,448, entitled “Patient Workflow Process”, filed Sep. 7, 2004 is hereby incorporated by reference in the entirety and made part hereof.

### FIELD OF THE INVENTION

To manage the Tablet MD™ environment between different servers and different Tablet PCs, the Patient Workflow Process (PWP) implements a global synchronization system and process that handles the coordination of these diverse environments to be used for backup and distribution of information.

### BACKGROUND OF THE INVENTION

Within the medical field, there are a number of commercial products that contain a variety of databases for patient personal data, medical records, procedures, equipment, billing, etc. These databases contain information that covers the patients, the providers, and the insurers, etc. For many of these commercial products, there are huge problems of privacy, security, and accountability that dampen their efficacy and reliability within the medical field. With numerous medical providers, e.g. doctors, nurses, technicians, residents, etc. entering information for a single patient from various places in one physical location (i.e. a hospital) or from several remote locations (e.g. a hospital, an outpatient clinic, a doctor's office, etc.), synchronization is key to forming a single, unified, and up-to-date record for any particular patient or medical practice.

The need for synchronizing this data is obvious, but is relatively little covered in the art. Further, the definition is variable. Synchronization is often confused with scheduling (of appointments, facilities, and reports, etc.), rather than that of data timing and priority. The importance of data timing and priority levels assigned to information is critical and cannot be taken for granted. Organizations depedent on information technology are struggling to manage complex heterogenous environments that incorporate distributed and disparate hardware, software, applications, networks and database systems. There have been attempts in the prior art to provide much-needed synchronization.

The treatment of the “collision” problem is critical to successful management of such heterogenous environments, wherein data sent from a plurality of sources conflict with respect to either priority, timing, or use of common facility or personnel at the same time. Such a conflict can be resolved by automated rules of by human decision. The inventive global synchronization system in the patent application set forth herein uses a process of “flagging” the problem to a human decision maker, where it is resolved and the results logged and implemented.

This technology implementation is not available in its entirety in any other commercially available product. Due to complexity of the information needing to be coordinated and the privacy and government regulations needing to be followed, global synchronization technology not only transports, but journals and transforms information to meet these requirements. Data synchronization is required between all Tablet MD installs within a Practice (e.g. medical practice) and from the Practice server(s) to the system's Corporate server. Herein, synchronization is an automated process but the user has the ability to initiate synchronization.

### SUMMARY OF THE INVENTION

Global Synchronization Technology comprises a system and process for the synchronization of a plurality of databases, preferably those associated with medical practices and healthcare. The system is comprised of databases and servers and remote terminals, some of which are mobile, and communications means between these items, plus external networks such as the Internet.

A first embodiment of the invention relates to a system for the synchronization of data within a practice, said system comprising a memory for storing a computer program that prescribes a suggested workflow for a healthcare professional-patient encounter; at least one wireless output device for displaying health-related information, including diagnostic and plan care information in accordance with the prescribed workflow; at least one wireless input device for entering diagnostic and plan care information in accordance with the prescribed workflow; at least one database for the storage of the health-related information; a host server connected to the at least one database, and at least one client server connected to the host server and the at least one wireless output and input devices; wherein the at least one wireless output and input devices transmit data to and receive data from the at least one client server, and the at least one client server transmits data to and receives data from the host server.

A second embodiment of the invention relates to a process of synchronizing data within a practice, said process comprising creating a new contact for the storage of patient information into at least one database; alternatively searching for an existing contact within the at least one database; entering patient information for the contact into at least one information field; saving the patient information into the at least one database; creating a new patient record on a communications device; producing an audit record of the patient record; securing a connection from the communications device to a network; transmitting data from at least one communications device to a server on the network to produce an update; sending audit records to the server; creating collision records where the at least one communications device transmits data to the server for the same information field; transferring collision records to a collision table; flagging the collision records; accessing a collision management screen to view the flagged collision records; manually selecting a collision record for storage into the at least one database; adding the selected collision record to an audit table; and producing a status screen on the at least one communications device.

A third embodiment of the invention relates to a server for the synchronization of within a practice, said server comprising at least one database for the storage of health-related information, wherein the database includes means for synchronizing and resolving conflicts from the storage of said health-related information.

A fourth embodiment of the invention relates to a system for the synchronization of data within a practice, said system comprising one or more internal and external computer databases or networks; a computer in data communications with the one or more internal and external databases or networks; and a memory associated with the computer for storing a computer program that prescribes a suggested workflow for a healthcare professional-patient encounter;

A fifth embodiment of the invention relates to a computer readable medium having a computer program thereon for synrchonizing data within a practice, the medium comprising a first code segment for the synchronization of data transmitted from at least one communications device to at least one server for storage onto a database; and a second code segment for providing confict resolution of the data data transmitted from the at least one communications device to the at least one server.

A sixth embodiment of the invention relates to a system for for the synchronization of data within a practice, said system comprising at least one wireless portable computing device including an input device and a display device for use during the workflow process, at least one server having at least one database, wherein the at least one wireless portable computing device in data communication with the at least one server; and a computer network to which the at least one server is connected, wherein modifications from the at least one database are transmitted to and from the at least one wireless input device and the at least one server.

It is an object of the invention to connect the terminals, typically PCs and PDAs, to the servers, which in turn interconnect them to the databases and each other. It is another object of the invention to provide interconnection means that can be wireless or hard wired. Another object of the invention is the setting of the above-identified elements on a common time base reference and setting data rates for proper communications between the elements of the system.

Still another object of the invention is to provide the system with specific protocols such as tablet MD for the portable terminals. It is yet another object of the invention to foster communications through Microsoft Visual Basic.NET Framework. Yet another object of the invention is to provide a mechanism for data collision resolution.

### BRIEF DESCRIPTION OF THE DRAWINGS

FIG. 1 illustrates a sample environment display for a Practice with three Offices.

FIG. 2 is a table relation diagram demonstrating the interrelationships between the at least six tables of the Global Synchronization Technology.

FIG. 3 is an example of a contacts screen in accordance with the present invention.

FIG. 4 is an example of a screen for inputting patient data.

FIG. 5 is an example of a status screen in accordance with the synchronization process of the present invention.

FIG. 6 is a first part of a synchronization process diagram detailing the synchronization process of the present invention.

FIG. 7 is a second part of a synchronization process diagram detailing the collision resolution process of the present invention.

### DESCRIPTION OF THE PREFERRED EMBODIMENT

The inventive synchronization system and process permits the utilization of the network server to maintain and backup the client Tablet MD systems transparently. This minimizes or eliminates the need for a practice to hire proficient computer staff, thus reducing costs, and minimizing errors. This includes data updates, including but not limited to medical classification systems, drug databases, new forms, and business rules. Every action taken by a user on either a Tablet MD connected through wireless protocols, or desktop or notebook computers connected over local area networks is captured in a journal file. The synchronization process takes place either automatically or upon initiation by the user, the practice server, or during actual network operations. These files act in two modes—backup and coordination.

In order to insure information collected is not lost, synchronization processes move the generated information on a field by field basis to the practice server when the Tablet is within wireless range of the server or is connected by an on/off-site LAN. Once the files are moved a procedure is initiated to update the server database as a backup. Each server also has a RAID sub-system to further backup the information. As a further backup, the preferred embodiment provides a service to automatically synchronize practice database modifications with a corporate facility transparent to the practice. Processes are started in the background and initiate the actions which need to be executed automatically. In other words, with the practice has a practice management system to provide scheduling and billing, Tablet MD will automatically initiate a transfer of new and changed appointments from the practice management system to Tablet MD.

Coordination takes several forms. The information backed up to a server, also can be used to synchronize with another user's Tablet PC or a series of servers situated at various geographic locations for a practice. This coordination insures the practice at all times its users are seeing the same and current data for a patient.

The synchronization process is also used to update practice information such as new forms, compliancy requirements, and drug databases. This information is automatically pushed out to user Tablet MD environments and made immediately available to desktop and notebook computer users. A system service is initiated to review the audit trail generated while a user works with Tablet MD and then sends the local Tablet PC records to the server automatically updating the database there.

Tablet MD Synchronization Terminology

The following terms will be used to describe elements of the Synchronization process. These definitions apply directly to the Global Synchronization system and process of the present invention.
Global Synchronization—the process of synchronizing data between all databases within the WiFiMed network of Practices using Tablet MD and the WiFiMed corporate server.
Practice—an organization with a group of related databases.
User—a person logged into the Tablet MD application and by performing tasks generates audit records (Item 10) and initiates synchronization processes.
Server—a computer that is only accessed remotely by users. All Servers contain a relational database.
Tablet—A Tablet (Tablet PC or Desktop PC) is the main data entry point for all data. The Tablet is accessed directly by the users and contains a relational database of the same type and format as the Server
Sync DNA—the shared data structure which maps databases as Nodes within the “DNA” structure.
Node—a single element of the Sync DNA structure. This could be a Server or a Tablet.
   Network Watcher
Network Watcher—an application that runs on a Node. The service periodically checks for network and server availability and logs the results so that other processes can determine if the network is available.
File Watcher—establishes relationships and pointers to Nodes and Practices
Audit Record—a single row entry in an Audit table. Audit records are generated by Insert and Update triggers.
Sync History Record—a single row entry in a Sync History table. Sync History records are generated when an audit record is applied to a Node. This record remains to prevent the same audit record from being transferred to the Node again.
   Global Synchronization Tables

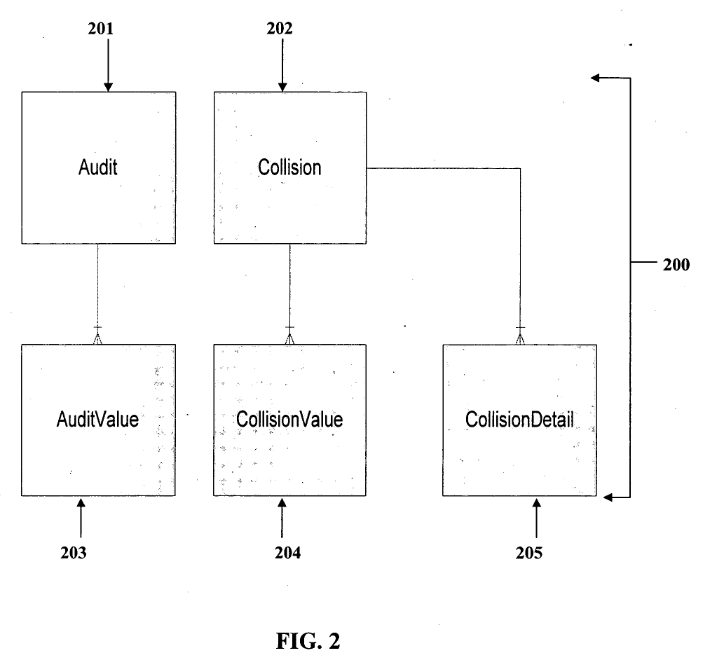

At least six tables are used in the synchronization process. FIG. 2 illustrates the relationships between the tables. The Audit table 201 contains the individual entries for each action which takes place on the Tablet or Server. Includes pointers to the table and its row and column being modified as well as the before and after value. Every entry in this table is sequenced and time stamped. The Audit Value Table 203 contains the actual values to be synchronized. There is a BeforeAfter column, which signifies whether the value in the Expression column is the Before or After value. The Collision Table 202 points to the Audit Table 201 and contains entries for any instant of a Table, Row, and Column which is a duplicate of another instant from another Tablet or Server. The records contain server and tablet audit create dates, table name and its unique identifier, the name of the column and unique identifier for the row. The Collision Detail Table 205 provides the detail behind the entries in the Collision Table 202. Each row in the table contains the field name being modified, the server value, and the before and after values on the tablet. This is used when managing collisions. The Collision Value Table 204 provides the values which are used in the collision process to indicate a value type and the value itself. Each entry in the Sync History Table 200 points to an audit record and shows which each of the audit elements have completed synchronization. The table contains the unique audit identifier and the unique identifier of the table being modified or updated. The table definitions are set forth in Appendix C.

Global Synchronization Processes

The types of data being moved via the inventive system and process represent the following: Encounters, Workflows, Forms, Components, Domain Knowledge, Result Options, Lookup Variables, Reporting Components, Decision Support Business Rules, System variables and preferences, and Security elements and components.

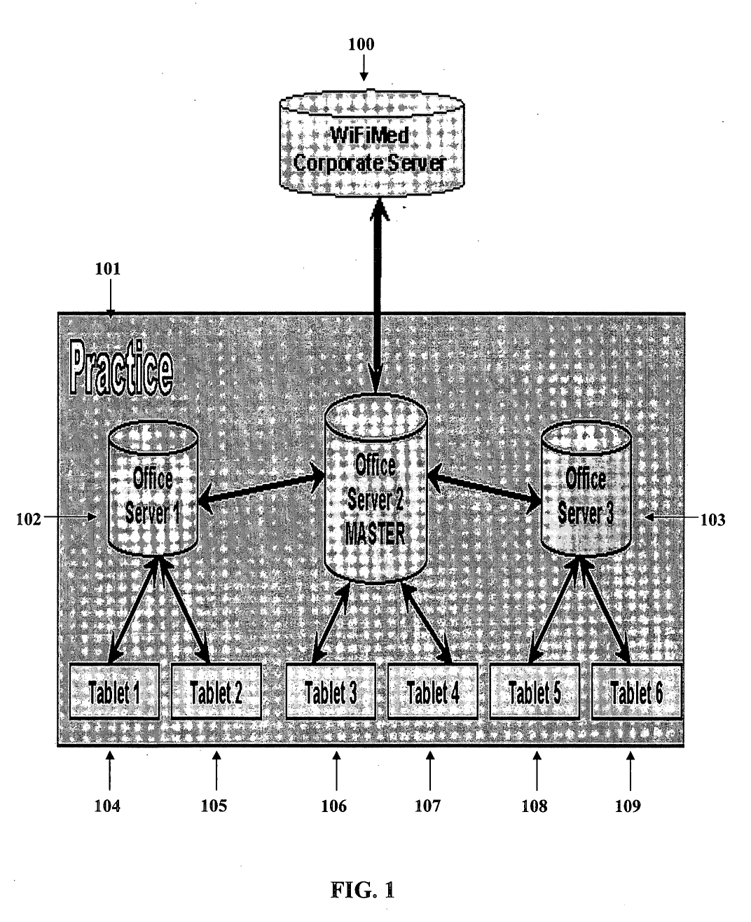

This text below describes the processes which will implement the Global Synchronization. This process is not only used for database synchronization but for updating Practice servers with database and code updates. The example is the creation of a patient record. The Sample Environment display in FIG. 1 demonstrates a Practice with three Offices. Each Office has two Tablets. The arrows indicate the flow of database between databases. This diagram will be referenced throughout this specification where an example is required.

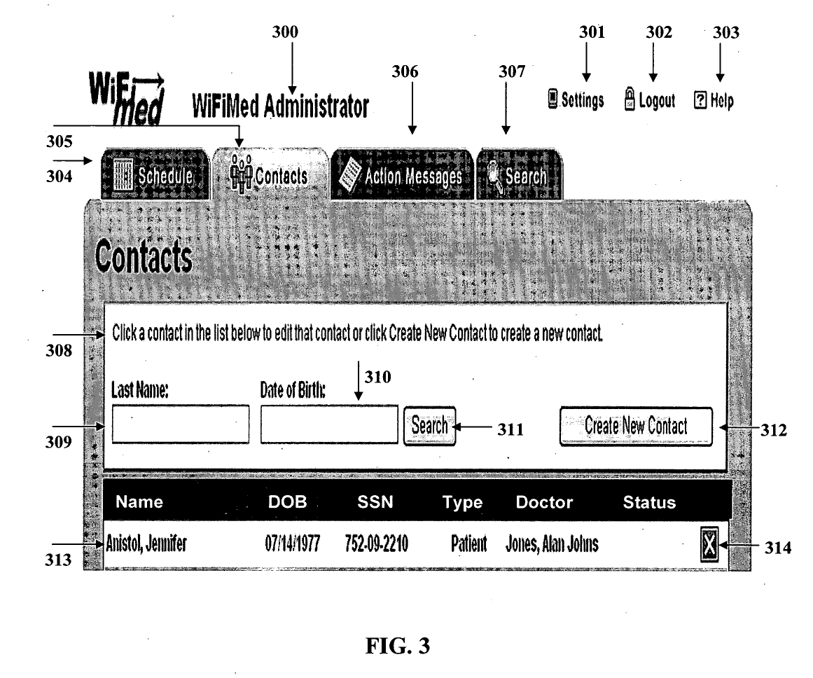

FIG. 3 demonstrates the mechanisms and processes by which the user performs the Sync process. To perform the Sync Process, the User, logs into Tablet 1, for example to arrive at the WiFiMed Administrator screen 300. If multiple practices are required by the Tablet user, the User enters a code to determine which practice is being accessed. On the right side of the screen 300, the user may is presented with buttons for implement settings 301, logout 302, or help information 303. At least four tabs are presented to the user from which to select—Schedule 304, Contacts 305, Action Messages 306, and Search 307. The user clicks on the Contacts tab 305.

Within the Contacts tab 305, the User is presented with instruction 307, which directs the user to click a contract in the list below to edit said contact or to click the “Create New Contact” button 312 to create a new contact. The User may also enter the Last Name 309 and the Date of Birth 310 for the contact and click the Search button 311 to bring up the desired contact. The list of contacts 313 will show the contact's name, date of birth, social security number, type, the name of the doctor assigned to the patient, and the patient's status. The contact may be removed from the list by clicking the delete button 314.

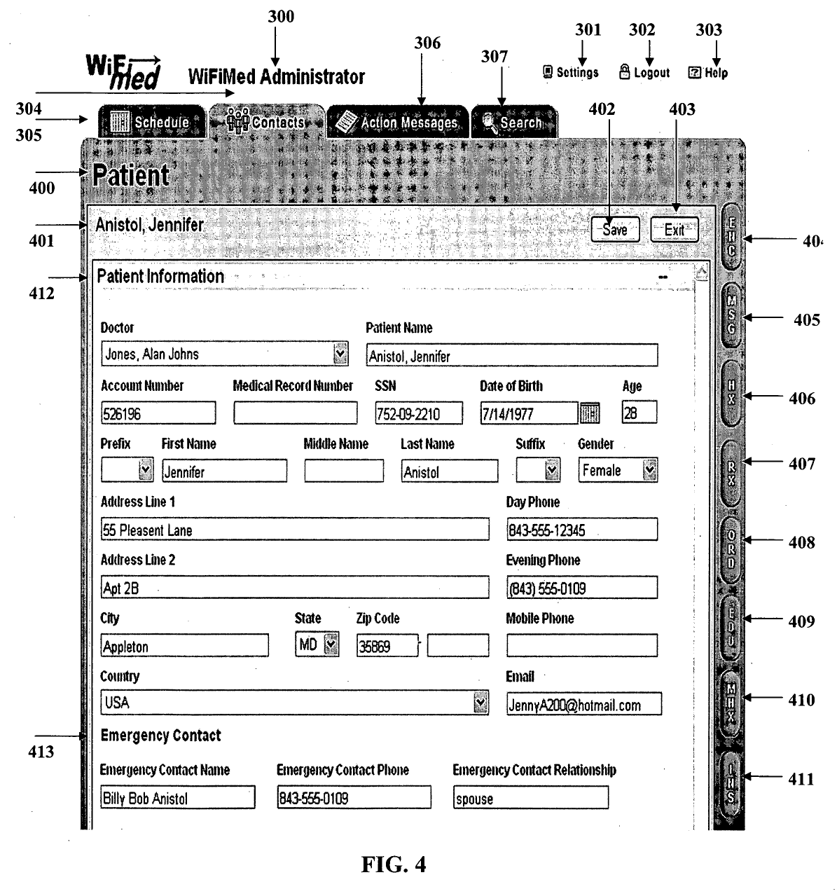

Following along with the example set forth herein, the User then clicks the Create New Contact button 312. FIG. 4 illustrates the mechanisms and processes required for the User to create and store the information for the desired contact within the WiFiMed Administrator 300. In addition to the main tabs 304 through 307 and buttons 301-303 described above, FIG. 4 presents detailed levels of information fields that the User will need to complete in order to create a comprehensive record for the desired contact. The Patient screen 401 contains three main information areas—the patient's name 401, the patient's information 412 and the patient's emergency contact information 413. It should be noted that on the side of the Patient screen 400, there are multiple buttons from which the user may select—encounter completion “ENC” 404, tickler action “MSG” 405, “MX” 406, prescriptions “RX” 407, order receipt “ORD” 408, “EDU” 409, “MHX” 410, and insurance “INS” 411.

Within Patient Information 412, the User is requested to complete information fields to store information such as the doctor assigned to the patient; the patient's name; the patient's account number; the medical record number; the social security number (SSN); the date of birth; the patient's age; a prefix for the patients' name (if applicable), the patient's first name, middle name, last name and suffix; the patient's gender; the address line 1, the address line 2, the city, the state, zipcode and country of the patient's residence; a daytime telephone number, and evening telephone number, a mobile phone number, and an email address. For the Emergency Contact information 413, the user inputs the emergency contact name, the emergency contact phone number, and the emergency contact's relationship to the patient.

The User enters Patient data and clicks the Save button 402. A new Patient record is created on the Tablet. The insert into the Patient table initiates the production of an Audit record.

With regard to the Network Watcher Process, the Network Watcher checks to see if connection to the network exists. If the network exists the DNA table is updated on the Node with an “available” status. If not, the DNA table is updated on the Node with an “unavailable” status.

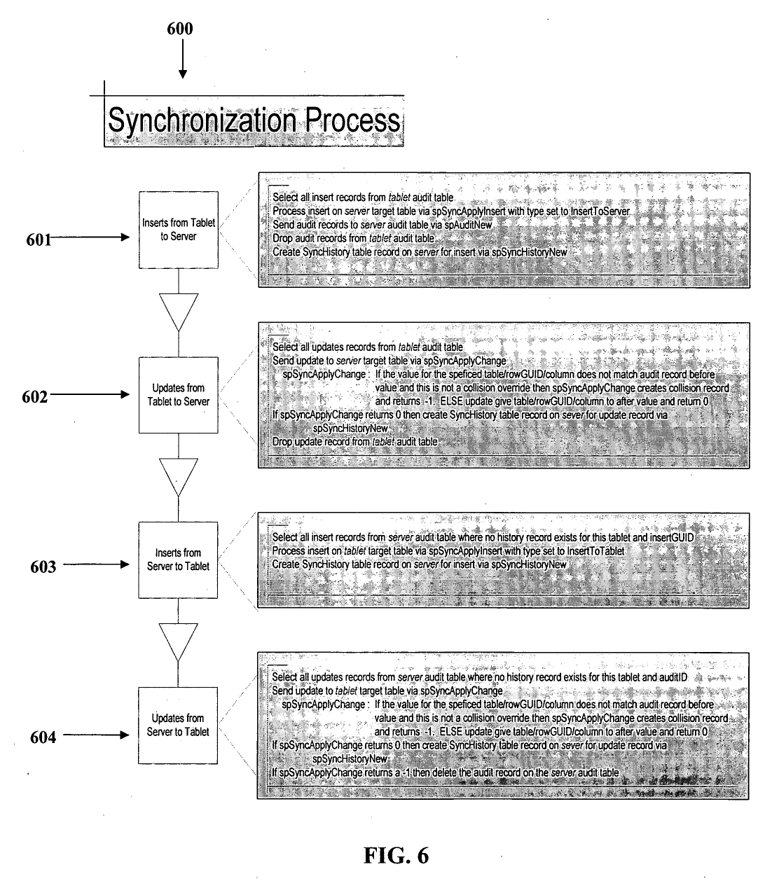

In the Synchronize Data Process illustrated in FIG. 6, a conduit is opened to pass records between Tablet 1 and the Server. Inserts and Updates are applied from the Tablet Node to the Server Node. Inserts and Updates are applied from the Server Node to the Tablet Node which were created from other Tablets or on the Server.

The Collision Management Process of the present invention is described as follows. At times, different tablets provide updates on the same record. Collision management handles these instances. Collisions are audit records sent to the server where two different sources have created audit records for the same field. Collision records are moved to the collision table. Within the Tablet MD application on the Server the user can go to the Collision Management screen and view all of the records that have been flagged as collisions. The user decides on what appropriate record to keep—a manual process. The record that has been chosen will be added back to the audit table to be propagated during the next sync.

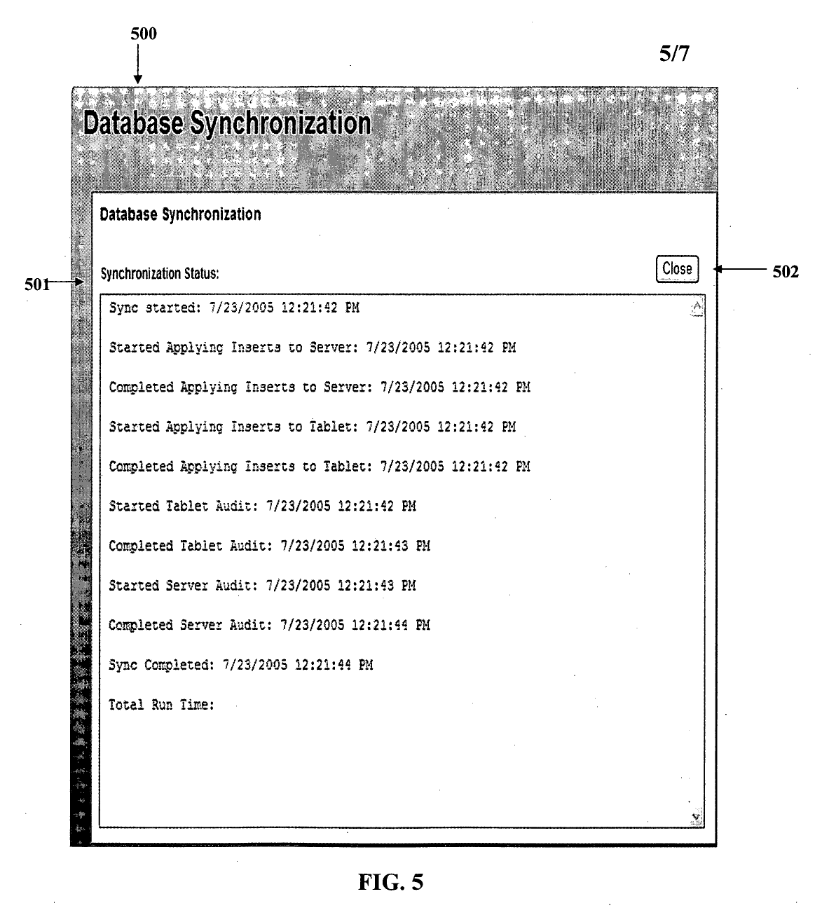

Within the Closed Loop Environment, for each Tablet associated with practice, each time that Tablet synchronizes with the server, audit records initiate updates to that Tablet to maintain exact replicas of the database on each Tablet or Server in the practice network. The status screen appears upon successful completion of synchronization. An exemplary status screen is illustrated in FIG. 5. The Database Synchnronization screen 500 comprises synchronization status 501 and close button 502, for closing the database synchronization screen 501 after the status is read.

The synchronization status 501 for the above-referenced example sets forth when the synchronization process started (e.g. Jul. 23, 2005 at 12:21:42 p.m.). Status 501 also details when the synchronization process began applying inserts to the server (e.g. Jul. 23, 2005 at 12:21:42 p.m.); when the synchronization process completed the application of inserts to the server (e.g. Jul. 23, 2005 at 12:21:42 p.m.); when the synchronization process started applying inserts to the tablets (e.g. Jul. 23, 2005 at 12:21:42 p.m.); when the synchronization process completed applying inserts to the tablets (e.g. Jul. 23, 2005 at 12:21:42 p.m.); when the synchronization process started tablet audit (e.g. Jul. 23, 2005 at 12:21:42 p.m.); when the synchronization process completed tablet audit (e.g. Jul. 23, 2005 at 12:21:43 p.m.); when the synchronization process started server audit (e.g. Jul. 23, 2005 at 12:21:43 p.m.); when the synchronization process completed server audit (e.g. Jul. 23, 2005 at 12:21:44 p.m.); when the synchronization process was completed (e.g. Jul. 23, 2005 12:21:44 p.m.), and the total run time.

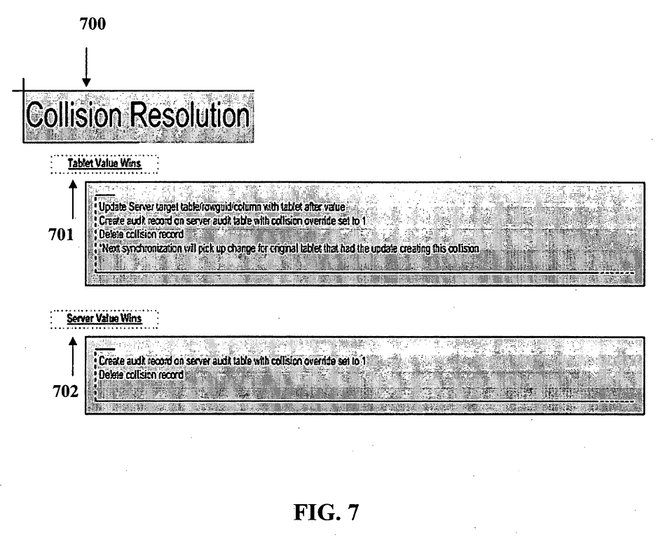

Details pertaining to the synchronization process, namely those related to the inserts and updates from/to servers and tables, are illustrated in FIG. 6. FIGS. 6 and 7 comprise the synchronization process diagram, and present information related to the synchronization process and collision resolution, respectively. In FIG. 6, the synchronization process 600 comprises inserts from one or more tablets to one ore more servers 601, updates from said tablet(s) to server(s) 602, inserts from server(s) to tablet(s) 603, and updates from server(s) to tablet(s) 604. In step 601, the global synchronization system selects all insert records from a tabled audit table. The insert is processed on a server target table via spSynchApplylnsert with type set to InsertToServer. The audit records are then sent to the server audit table via spAuditNew. The audit records are dropped from the tablet audit table. Finally, a SyncHistory table record is created on the server for insert via spSyncHistoryNew.

In step 602, all updated records are selected from the tablet audit table. The update is sent to the server target table via spSyncApplyChange. If the value for the specified table or row or GUID or column does not match the audit record before value and a collision override does nto exist, then spSyncApplyChange creates collisiona record and returns −1. Otherwise, the update gives table or row or GUID or colum to after value and returns 0. If spSyncApplyChange returns 0, then a SyncHistory table record is created on the server for update via spSyncHistoryNew. The update record is then dropped from the tablet audit table.

In step 603, all insert records are selected from the server audit table where no history record exists for the specified tablet and insertGUID. The insert is processed on the tablet target table via spSyncApplylnsert with type set to InsertToTablet. A SyncHistory table record is created on the server for insert via spSyncHistoryNew.

In step 604, all updates records are selected from the server audit table where no history record exists for the specified tablet and audited. The update is sent to tablet target table via spSyncApplyChange. If the value for the specified table or row or GUID or column does not match the audit record before value and a collision override does nto exist, then spSyncApplyChange creates collisiona record and returns −1. Otherwise, the update gives table or row or GUID or column to after value and returns 0. If spSyncApplyChange returns 0, then a SyncHistory table record is created on the server for update via spSyncHistoryNew. If spSyncApplyChange returns a −1, then the audit record is deleted on the server audit table.

The inventive system has a collision feature to resolve synchronization conflicts. This can occur when plural sources have sent data to the same field. This occurrence flags a Collision to the server, which call the appropriate records to the attention of a user, who decides manually which records have priority. This will be corrected on the next synchronization cycle. FIG. 7 provides pertinent details with reference to collision resolution.

Within collision resolution 700, there are at least two routes for the resolution of data conflicts—“tablet value wins” 701 and “server value wins” 701. To implement “tablet value wins” 701, the system updates server target table or row or GUID or column with tablet after value. An audit record is created on the server audit table with the collision override feature set to 1. The collision record is deleted. The next synchronization cycle will detect the change for the original tablet which had the update that caused the collision.

To implement “server value wins” 702, an audit record is created on the server audit table with the collision override feature set to 1. The collision record is then deleted.

Appendix A contains the source code for the global synchronization process.

Appendix B contains the stored procedures source code for the global synchronization process.

Appendix C contains the table definitions for the global synchronization system and process.

What is claimed is:

1. A system for the synchronization of data within a practice, said system comprising:
(a) a memory for storing a computer program that prescribes a suggested workflow for a healthcare professional-patient encounter;
(b) at least one wireless output device for displaying health-related information, including diagnostic and plan care information in accordance with the prescribed workflow;
(c) at least one wireless input device for entering diagnostic and plan care information in accordance with the prescribed workflow;
(d) at least one database for the storage of the health-related information;
(e) a host server connected to the at least one database, and
(f) at least one client server connected to the host server and the at least one wireless output and input devices; wherein the at least one wireless output and input devices transmit data to and receive data from the at least one client server, and the at least one client server transmits data to and receives data from the host server.

2. The system of claim 1, wherein the at least one database comprises an audit table.

3. The system of claim 1, wherein the at least one database comprises an audit value table.

4. The system of claim 1, wherein the at least one database comprises a collision table.

5. The system of claim 1, wherein the at least one database comprises a collision detail table.

6. The system of claim 1, wherein the at least one database comprises a collision value table.

7. The system of claim 1, wherein the at least one database comprises a sync history table.

8. The system of claim 1, wherein the health-related information comprises encounters, workflows, forms, components, domain knowledge, result options, lookup variables, reporting components, decision support business rules, system variables and preferences, and security elements and components.

9. A process of synchronizing data within a practice, said process comprising:
a) creating a new contact for the storage of patient information into at least one database;
b) alternatively searching for an existing contact within the at least one database;
c) entering patient information for the contact into at least one information field;
d) saving the patient information into the at least one database;
e) creating a new patient record on a communications device;
f) producing an audit record of the patient record;
g) securing a connection from the communications device to a network;
h) transmitting data from at least one communications device to a server on the network to produce an update;
i) sending audit records to the server;
j) creating collision records where the at least one communications device transmits data to the server for the same information field;
k) transferring collision records to a collision table;
l) flagging the collision records;
m) accessing a collision management screen to view the flagged collision records;
n) manually selecting a collision record for storage into the at least one database;
o) adding the selected collision record to an audit table; and
p) producing a status screen on the at least one communications device.

10. The process of claim 9, wherein the at least one communications device may be a wireless output device for displaying health-related information, including diagnostic and plan care information.

11. The process of claim 9, wherein the at least one communications device may be a a wireless input device for entering diagnostic and plan care information.

12. A server for the synchronization of within a practice, said server comprises:
a) at least one database for the storage of health-related information, wherein the database includes means for synchronizing and resolving conflicts from the storage of said health-related information.

13. The server of claim 12, wherein the at least one database comprises an audit table.

14. The server of claim 12, wherein the at least one database comprises an audit value table.

15. The server of claim 12, wherein the at least one database comprises a collision table.

16. The server of claim 12, wherein the at least one database comprises a collision detail table.

17. The server of claim 12, wherein the at least one database comprises a collision value table.

18. The server of claim 12, wherein the at least one database comprises a sync history table.

19. The server of claim 12, wherein the health-related information comprises encounters, workflows, forms, components, domain knowledge, result options, lookup variables, reporting components, decision support business rules, system variables and preferences, and security elements and components.

20. A system for the synchronization of data within a practice, said system comprising:
(a) one or more internal and external computer databases or networks;
(b) a computer in data communications with the one or more internal and external databases or networks;
(c) a memory associated with the computer for storing a computer program that prescribes a suggested workflow for a healthcare professional-patient encounter;

21. The system of claim 20, wherein the computer may be a wireless input device for entering diagnostic and plan care information.

22. The system of claim 20, wherein the computer may be a wireless output device for displaying health-related information, including diagnostic and plan care information.

23. A computer readable medium having a computer program thereon for synrchonizing data within a practice, the medium comprising:
a) a first code segment for the synchronization of data transmitted from at least one communications device to at least one server for storage onto a database; and
b) a second code segment for providing confict resolution of the data data transmitted from the at least one communications device to the at least one server

24. A system for for the synchronization of data within a practice, said system comprising:
(a) at least one wireless portable computing device including an input device and a display device for use during the workflow process,
(b) at least one server having at least one database, wherein the at least one wireless portable computing device in data communication with the at least one server; and
(c) a computer network to which the at least one server is connected, wherein modifications from the at least one database are transmitted to and from the at least one wireless input device and the at least one server.

25. The system of claim 24, wherein the at least one database comprises an audit table.

26. The system of claim 24, wherein the at least one database comprises an audit value table.

27. The system of claim 24, wherein the at least one database comprises a collision table.

28. The system of claim 24, wherein the at least one database comprises a collision detail table.

29. The system of claim 24, wherein the at least one database comprises a collision value table.

30. The system of claim 24, wherein the at least one database comprises a sync history table.
